(19) United States
(12) Patent Application Publication
(10) Pub. No.: US 2014/0062467 A1
(43) Pub. Date: Mar. 6, 2014

(54) WATERPROOF CODING DEVICE WITH BUILT-IN MAGNETIC DISC

(71) Applicants: Jia WANG, Shenzhen (CN); Xiuwen YANG, Shenzhen (CN); Jianzhuo YANG, Shenzhen (CN)

(72) Inventors: Jia WANG, Shenzhen (CN); Xiuwen YANG, Shenzhen (CN); Jianzhuo YANG, Shenzhen (CN)

(21) Appl. No.: 14/010,894

(22) Filed: Aug. 27, 2013

(30) Foreign Application Priority Data
Aug. 28, 2012 (CN) 201210309527.3

(51) Int. Cl. G01B 7/30

(52) U.S. Cl. CPC G01B 7/30
USPC 324/207.25

(57) ABSTRACT

A waterproof coding device with a built-in magnetic disc, comprising: a magnetic disc; a knob with a shaft, elastic positioning pieces and a magnet conducting ring; a positioning shaft, the magnetic disc and an inductive circuit board being mounted on the positioning shaft; and, a circular support base being located above a panel, the wall of the base is provided with positioning grooves; the head part of the positioning shaft is penetrated through the panel to be screwed; the knob is mounted on the base, the shaft is movably fitted with a sleeve inside the base, the magnet conducting ring is gripped by magnets on the magnetic disc so that the magnetic disc can rotate synchronously with the knob. The coding device has the advantages of compact structure, water tightness and shock resistance, and is specifically suitable for applications in high-humidity environments and occasions with high shock possibility.

### TECHNICAL FIELD OF THE INVENTION

The invention relates to a waterproof coding device with a built-in magnetic disc, used for converting angular displacement into angular displacement pulse-coded signals.

### BACKGROUND OF THE INVENTION

As sensor devices for converting angular displacement or linear displacement signals into coded digital signals, coders, including mechanical coders, electromagnetically inductive coders, photoelectric coders and magnetically inductive coders, which are varied in structure, have been widely used in industrial control, measurement for rotation speed, power regulation and other fields. However, because of the structure of coders, the coders are difficult to be sealed or sealed insufficiently, so that the use of coders onto electric appliances in high-humidity environments, such as kitchens, bathrooms and other similar places is rather constricted, due to inadequate safety.

When the existing coding devices are used in shock occasions, some knobs may have small-amplitude rotation, resulting in variations of output signals of the coding devices and further influencing the precision of measurement and control.

Permanent magnets of the existing magnetically inductive coding devices are almost disposed in knobs on panels, and the knobs are positioned mechanically, adverse to the miniaturization design of the knobs.

### SUMMARY OF THE INVENTION

To avoid the above deficiencies of the existing coding devices, the invention provides a waterproof coding device with a built-in rotatable magnetic disc, with advantages of compact structure and low cost, so that the coding device may work safely and stably even in high-humidity environments and when affected by shocks.

The invention provides a waterproof coding device with a built-in magnetic disc, comprising:

a magnetic disc, a approximate periphery part of which is distributed with a plurality of magnets at intervals;

a knob that is provided therein with a shaft or shaft sleeve, 2 to 4 elastic positioning pieces being provided around the shaft or shaft sleeve, an outer wall of the knob being provided thereon with an annular cavity, and a magnetic conducting ring being provided at an opening of the annular cavity;

an inductive circuit board, provided with a magnetically sensitive element for detecting angular displacement signals of both the knob and the magnetic disc;

a positioning shaft comprising a head part, a middle part and a tail part, the magnetic disc being mounted in the middle part of the positioning shaft by a bearing or shaft collar, and the inductive circuit board being fixed at the tail part of the positioning shaft close to the magnetic disc; and,

a circular support base, the center of which being provided with a sleeve while the peripheral wall of which is provided with positioning grooves. The circular support base is located above a panel. The head part of the positioning shaft is penetrated through an installation hole of the panel from inside to outside to be screwed with the head part by a fastening screw or a screw on a shaft with a screw in the sleeve. The knob is mounted on the support base. The shaft of the knob is movably fitted with the sleeve inside the support base, or the shaft sleeve of the knob is movably fitted with the shaft with a screw. The elastic positioning pieces of the knob are corresponding to the corresponding positioning grooves on the peripheral wall of the circular support base. The magnetic conducting ring is gripped by a plurality of magnets on the magnetic disc so that the magnetic disc can rotate synchronously with the knob.

A waterproof sealing gasket is also provided between the circular support base and the panel.

The upper end of the head part of the positioning shaft is provided with a first positioning plane that is fitted with an external axle hole with a positioning face on the bottom surface of the sleeve in the circular support base, while the tail part thereof is provided with a second positioning plane that is fitted with a flat center hole of the inductive circuit board, to ensure the initial positions of the magnetically sensitive element of the inductive circuit board and the positioning grooves on the circular support base.

The magnetic disc comprises a plastic disc. An installation hole is provided in the middle of the plastic disc. A number of cavities, in each one of which one cylindrical magnet is inlaid, are spaced-apart in an approximate periphery part on the same circumference.

The magnetic disc may also be an integral magnetic disc molded from the mixture of plastics and magnetizing powders; and the approximate periphery part on the same circumference is magnetized partially to form a plurality of magnets.

Two adjacent magnets on the magnetic disc have opposite polarities.

The inductive circuit board on the positioning shaft should be mounted as close as possible to the magnetic disc, and the distance from the lower surfaces of the magnets on the magnet disc to the magnetically sensitive element on the inductive circuit board is 0.2-3.5 mm, preferably 0.5-2 mm.

On the inner top surface of the knob, 2 to 4 elastic positioning pieces extend downward, for fitting and positioning the corresponding positioning grooves on the peripheral wall of the circular support base. Also, the internal top surface of the knob may be riveted downward with 2 to 4 elastic positioning pieces for fitting and positioning the corresponding positioning grooves on the peripheral wall of the circular support base.

In the coding device provided by the invention, a rotatable magnetic disc and an inductive circuit board are built in the panel of a chassis. The magnet conducting ring in the knob on the panel is gripped by the built-in magnetic disc to axially position the knob by magnetic force. Meanwhile, due to the fitting and positioning between the elastic positioning pieces in the knob and the positioning grooves of the circular support base, the knob will not rotate when shocked. But, when the knob is subjected to a manual torsion, the magnetic disc rotates synchronously with the knob, and the magnetically sensitive element of the inductive circuit board outputs pulse-coded signals representing angular displacement between the knob and the magnetic disc.

The magnetic disc and the inductive circuit board built in the panel of the chassis are mounted and positioned by a positioning shaft, so the inductive circuit board is closer to the magnetic disc. The distance from the lower surface of the magnets on the magnetic disc to the magnetically sensitive element on the inductive circuit board decreases, so that the amplitude of output signals of the magnetically sensitive element is increased and the cost of amplification for subsequent signals is reduced.

Being compact in structure, advantageous to the miniaturization design of a knob and beneficial for waterproof sealing, with the advantages of shock resistance and low cost, the waterproof coding device with a built-in magnetic disc provided by the invention is particularly suitable for applications in high-humidity environments and occasions with high shock possibility.

### BRIEF DESCRIPTIONS OF THE DRAWINGS

FIG. 1 is a three-dimensional exploded view of a coding device in Embodiment 1;

FIG. 2 is a cutaway view of FIG. 1;

FIG. 3 is an enlarged view of a positioning shaft as shown in FIG. 1;

FIG. 4 is a structure diagram of a coding device in Embodiment 2; and

FIG. 5 is a schematic diagram of a shaft 11′ with a screw 112′ as shown in FIG. 4, where the screw 112′ is used for fastening the circular support base 20 with the positioning shaft 50.

### DETAILED DESCRIPTIONS OF THE PREFERRED EMBODIMENTS

The invention will be further described as below by embodiments with reference to the drawings.

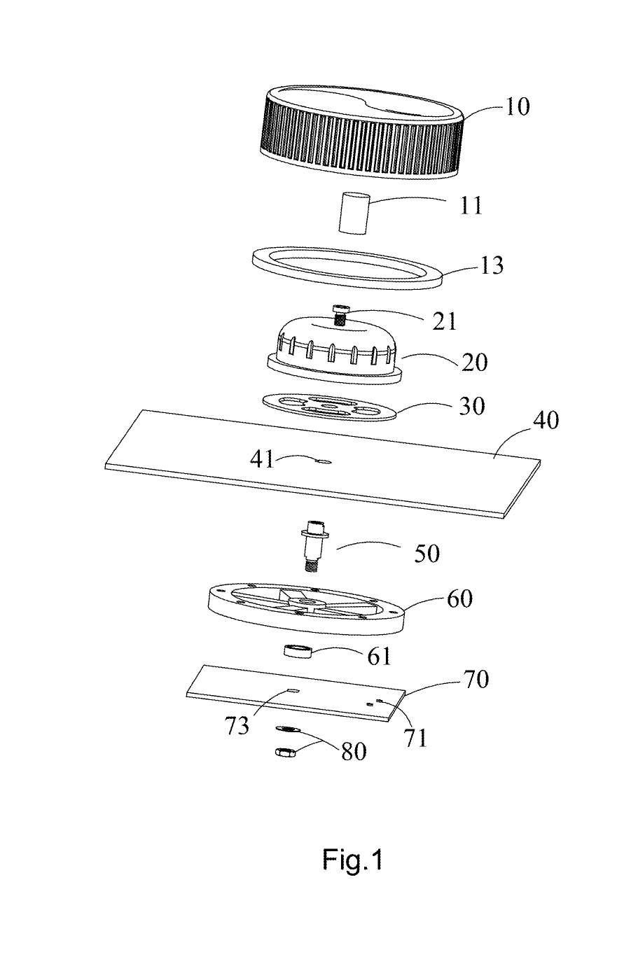

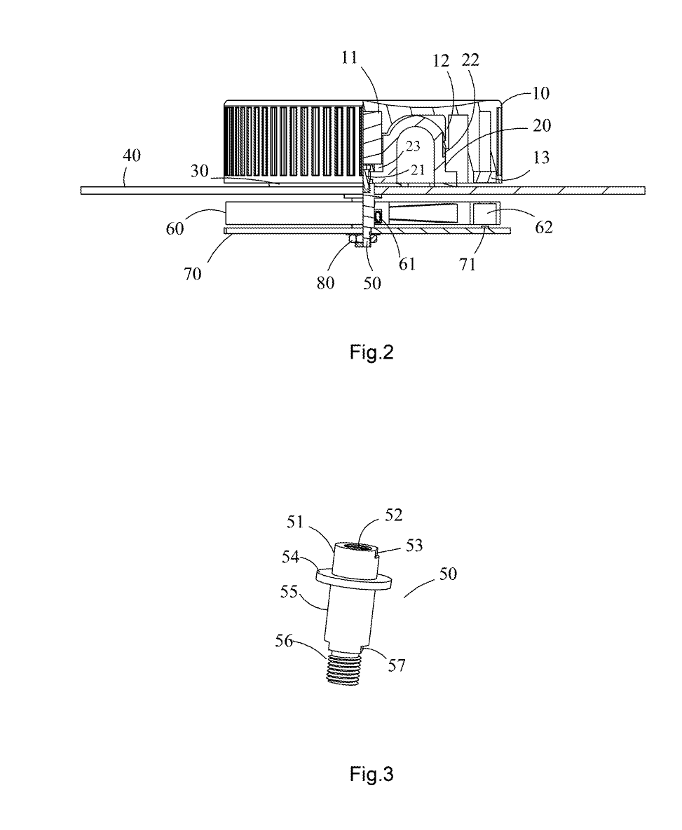

Referring to FIG. 1 to FIG. 3, Embodiment 1 provides a waterproof coding device with a built-in magnetic disc, mainly comprising: a knob 10 with a magnetic conducting ring 13, a circular support base 20, a positioning shaft 50, a magnetic disc 60, an inductive circuit board 70, a waterproof sealing gasket 30 between the circular support base 20 and a panel 40, etc.

The magnetic disc 60 comprises a plastic disc, in the middle of which an installation hole (used for installing a bearing or shaft collar 61) is provided. Eight cavities, in each one of which one cylindrical magnet 62 is inlaid, are spaced-apart in an approximate periphery part on the same circumerence. Two adjacent magnets 62 on the magnetic disc 60 have opposite polarities. The cylindrical magnets may be neodymium-iron-boron magnets, etc.

The magnetic disc 60 may also be molded from the mixture of plastics and magnetizing powders, and a number of magnets 62 are distributed at internals in the approximate periphery part of the magnetic disc 60 by means of partial magnetizing.

The inductive circuit board 70 is provided thereon with a flat center hole 73 and two Hall elements (or magnetically sensitive tubes) 71 for detecting signals representing angular displacement between the knob and the magnetic disc. The two Hall elements are distributed on one circumference corresponding to the eight magnets 62 on the magnetic disc 60, and an included angle between two lines of the two Hall elements and a circle center is 22.5°.

The peripheral wall of the circular support base 20 is provided thereon with a plurality of positioning grooves 22. A sleeve 23 (acting as a shaft sleeve) is provided in the center of the circular support base 20.

The positioning shaft 50 of FIG. 3 comprises a head part 51 with a screw hole 52, a middle part 55, a check ring 54 between the head part 51 and the middle part 55, and a tail part 56. The magnetic disc 60 is mounted in the middle part 55 of the positioning shaft 50 by a bearing or shaft collar 61. The inductive circuit board 70 is screwed at the tail part 56 of the positioning shaft 50 by a fastener 80 (for example, a bolt, a gasket). The upper end of the heat part 51 of the positioning shaft 50 is provided with a first positioning plane 53 that is fitted with an external axle hole with a positioning face on the bottom surface of the sleeve 23 in the circular support base 20, while a threaded section at the tail part 56 thereof is provided thereon with a second positioning plane 57 that is fitted with the flat center hole 73 of the inductive circuit board 70, to ensure the initial positions of the magnetically sensitive element 71 of the inductive circuit board 70 and the positioning grooves 22 on the circular support base 20. The circular support base 20 is located above the panel 40 (for example, a plastic panel, an aluminum panel, etc.). The head part 51 of the positioning shaft 50 is penetrated through the installation hole 41 on the panel 40 and the waterproof sealing gasket 30 from inside to outside. The first positioning plane 53 of the heat part 51 is fitted with the external axle hole (not shown) with a positioning face on the bottom surface of the sleeve 23 in the circular support base 20, and screwed with the screw hole 52 of the head part 51 of the positioning shaft 50 by a fastening screw 21 in the sleeve 23.

The middle part of the inner top surface of the knob 10 is provided therein with a shaft 11. On the inner top surface of the knob 10, 2 or 4 elastic positioning pieces 12 extend downward around the shaft 11, and lower ends of the elastic positioning pieces 12 are provided with protrusion portions for fitting and positioning the corresponding positioning grooves 22 on the peripheral wall of the circular support base 20. An outer wall of the knob 10 is provided thereon with an annular cavity, and the magnetic conducting ring 13 is provided at an opening of the annular cavity. The knob 10 is mounted on the circular support base 20. The shaft 11 of the knob 10 is movably fitted with the sleeve 23 in the circular support base 20. The elastic positioning pieces 12 of the knob 10 correspond to the corresponding positioning grooves 22 on the periphery of the circular support base (the positioning grooves 22 are fitted with the protrusion portions of the elastic positioning pieces 12). The magnetic conducting ring 13 is gripped by the plurality of magnets 62 on the magnetic disc 60 so that the magnetic disc 60 can rotate synchronously with the knob 10. When the magnetic disc 60 rotates synchronously with the knob 10, the two Hall elements 71 on the inductive circuit board 70 output pulse-coded signals representing angular displacement between the knob and the magnetic disc.

The top surface profile of the circular support base 20 is a circular arc. The circular arc and the inner top surface of the knob 10 form a waterproof sealing line. A positioning ring may also be provided on the inner top surface of the knob 10, and the edge of the collar of the positioning ring extends downward to form a plurality of elastic positioning pieces 12 with protrusion portions.

In Embodiment 1 described above, the magnetic disc 60 and the inductive circuit board 70 built in the panel of the chassis are mounted and positioned by the positioning shaft 50, so that the inductive circuit board is closer to the magnetic disc, which is advantageous to increase the amplitude of output signals of the Hall elements 71 and reduce the cost of amplification processing for backward signals. The distance from the lower surfaces of the magnets 62 on the magnet disc 60 to the Hall elements 71 on the inductive circuit board 70 is 0.2-3.5 mm, preferably 0.5-2 mm.

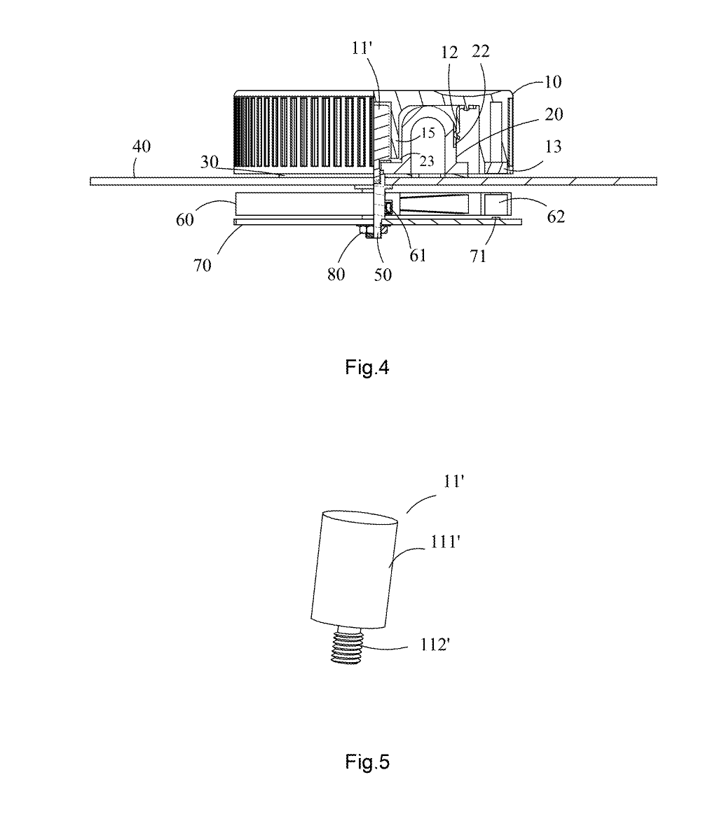

Embodiment 2 provides a waterproof coding device with a built-in magnetic disc, referring to FIG. 4 and FIG. 5. Embodiment 2 has a major structure basically the same as Embodiment 1, mainly comprising a knob 10 with a magnetic conducting ring 13, a circular support base 20, a positioning shaft 50, a magnetic disc 60, an inductive circuit board 70, a waterproof sealing gasket 30 between the circular support base 20 and a panel 40, etc.

The difference is that Embodiment 2 has a shaft 11′ with a screw as shown in FIG. 5. The shaft 11′ with a screw comprises a shaft 111′ and a screw 112′ extended from one end of the shaft 111′. The shaft 11′ with a screw is used for replacing the shaft 11 of the knob 10 and the fastening screw 21 in Embodiment 10

With the use of the shaft 11′ with a screw, the knob 10 changes somewhat. In the middle part of the inner top surface of the knob 10, a shaft sleeve 15 extends downward. The inner top surface of the knob 10 is riveted with four elastic positioning pieces 12 around the shaft sleeve 15. The elastic positioning pieces 12 are impact molded from elastic metal sheets. The lower ends of the elastic positioning pieces 12 are provided with protrusion portions fitted with the corresponding positioning grooves 22 on the peripheral wall of the circular support base 20. The outer wall of the knob 10 is still provided thereon with an annular cavity. The magnetic conducting ring 13 is provided at an opening of the annular cavity.

Similar to Embodiment 1, the magnetic disc 60 is mounted in the middle part of the positioning shaft 50 by a bearing 61. The inductive circuit board 70 is fixed at the tail part of the positioning shaft 50 by a fastener 80. The circular support base 20 is located above the panel 40. The head part of the positioning shaft 50 is penetrated through the installation hole of the panel 40 and the waterproof sealing gasket 30 from inside to outside of the chassis. The first positioning plane of the head part is fitted with the external axle hole (not shown) with a positioning face on the bottom surface of the sleeve 23 in the circular support base 20 to be screwed inside the sleeve 23 with the head part of the positioning shaft 50 by the screw 112′ of the shaft 11′ with a screw.

The knob 10 is mounted on the circular support base 20. The shaft sleeve 15 of the knob 10 is movably fitted with the shaft 11′ with a screw. The elastic positioning pieces 12 of the knob 10 correspond to the corresponding positioning grooves 22 on the peripheral wall of the circular support base 20. The magnetic conducting ring 13 is gripped by the plurality of magnets 62 on the magnetic disc 60 so that the magnetic disc 60 can rotate synchronously with the knob 10.

In FIG. 4, the top surface of the circular support base 20 is in line contact with the inner top surface of the knob 10 to form a waterproof sealing line.

The embodiments instanced above and descriptions thereof are only provided for describing the invention in details, and should not be regarded as any restriction to the invention. All of various alternative designs made depending on the listed scope of the claims should fall into the patent scope of the invention.

What is claimed is:

1. A waterproof coding device with a built-in magnetic disc, comprising:
a magnetic disc, a approximate periphery part of which is distributed with a plurality of magnets at intervals;
a knob that is provided therein with a shaft or shaft sleeve, 2 to 4 elastic positioning pieces being provided around the shaft or shaft sleeve, an outer wall of the knob being provided thereon with an annular cavity, a magnetic conducting ring being provided at an opening of the annular cavity;
an inductive circuit board, provided with a magnetically sensitive element for detecting angular displacement signals of both the knob and the magnetic disc;
a positioning shaft comprising a head part, a middle part and a tail part, the magnetic disc being mounted in the middle part of the positioning shaft by a bearing or shaft collar, and the inductive circuit board being fixed at the tail part of the positioning shaft close to the magnetic disc; and,
a circular support base, the center of which being provided with a sleeve while the peripheral wall of which is provided with positioning grooves, the support base being located above a panel, the head part of the positioning shaft being penetrated through an installation hole of the panel from inside to outside to be screwed with the head part by a fastening screw or a screw on a shaft with a screw in the sleeve; the knob being mounted on the support base, the shaft of the knob being actively matched with the sleeve in the support base or the shaft sleeve of the knob being movably fitted with the shaft with a screw, the elastic positioning pieces of the knob being corresponding to the corresponding positioning grooves on the peripheral wall of the circular support base, and the magnetic conducting ring being gripped by the plurality of magnets on the magnetic disc so that the magnetic disc can rotate synchronously with the knob.

2. The coding device according to claim 1, wherein a waterproof sealing gasket is provided between the circular support base and the panel.

3. The coding device according to claim 2, wherein the top surface of the circular support base is in line contact with the inner top surface of the knob, to form a waterproof sealing line.

4. The coding device according to claim 1, wherein the upper end of the head part of the positioning shaft is provided with a first positioning plane that is fitted with an external axle hole with a positioning face on the bottom surface of the sleeve in the circular support base, while the tail part thereof is provided with a second positioning plane that is fitted with a flat center hole of the inductive circuit board, to ensure the initial positions of the magnetically sensitive element of the inductive circuit board and the positioning grooves on the circular support base.

5. The coding device according to claim 1, wherein, on the inner top surface of the knob, 2 to 4 elastic positioning pieces extend downward, for fitting and positioning the corresponding positioning grooves on the peripheral wall of the circular support base.

6. The coding device according to claim 1, wherein the inner top surface of the knob is riveted downward with 2 to 4 elastic positioning pieces used for fitting and positioning the corresponding positioning grooves on the peripheral wall of the circular support base.

7. The coding device according to claim 1, wherein the magnetic disc is an integral magnetic disc molded from the mixture of plastics and magnetizing powders, and the approximate periphery part of the magnetic disc is magnetized partially to form a plurality of magnets.

8. The coding device according to claim 7, wherein two adjacent magnets on the magnetic disc have opposite polarities.

9. The coding device according to claim 7, wherein the distance from the lower surfaces of the magnets on the magnet disc to the magnetically sensitive element on the inductive circuit board is 0.2-3.5 mm.

10. The coding device according to claim 1, wherein two adjacent magnets on the magnetic disc have opposite polarities.

11. The coding device according to claim 1, wherein the distance from the lower surfaces of the magnets on the magnet disc to the magnetically sensitive element on the inductive circuit board is 0.2-3.5 mm.

12. The coding device according to claim 1, wherein the top surface of the circular support base is in line contact with the inner top surface of the knob, to form a waterproof sealing line.
